(19) United States
(12) Patent Application Publication
(10) Pub. No.: US 2008/0266845 A1
(43) Pub. Date: Oct. 30, 2008

(54) Auxiliary lighting device

(75) Inventors: Ching-Huei Wu, San Chung City (TW); Ching-Mo Wu, San Chung City (TW)

Correspondence Address: TROXELL LAW OFFICE PLLC, SUITE 1404, 5205 LEESBURG PIKE, FALLS CHURCH, VA, 22041, US

(73) Assignee: Unity Opto technology Co., Ltd.

(21) Appl. No.: 11/790,472

(22) Filed: Apr. 25, 2007

(51) Int. Cl. F21L 4/00

(52) U.S. Cl. 362/157

(57) ABSTRACT

The present invention relates to an auxiliary lighting device, which comprises a casing. The casing has a central through hole. At least one light-emitting device and at least one battery are mounted inside the casing. The light-emitting device is electrically connected to the battery for providing auxiliary illumination.

### FIELD OF THE INVENTION

The present invention relates to an auxiliary lighting device that couples with an article such as a hand tool or the like for providing auxiliary illumination.

### BACKGROUND OF THE INVENTION

There exists insufficient intensity of illumination when conventional hand tool is utilized at night or applied to the back of the machine or the dark gap. In such a condition, a helper is required to hold a flashlight for lighting up the operation position or the user must himself hold the hand tool by one hand and hold the flashlight by the other hand for lighting up the operation position. The user even have to keep a light pen or other small lighting device in the mouth for lighting up the operation position when he holds the hand tool by both hands.

It is very inconvenient when the operation position is short of sufficient intensity of illumination. Therefore, an auxiliary lighting device for coupling with a hand tool has been disclosed to facilitate the operation. For example, the published Taiwan Patent No. 459,603 has disclosed an improved hand tool with an auxiliary lighting device. In this case, the metal handle of the hand tool has a hollow chamber penetrating therethrough, wherein the hollow chamber has mounted therein a light bulb, a spring device, a battery set, a metal spring and a metal knob. Accordingly, the hand tool can be provided with the illumination by rotating the metal knob. Still an example, the published Taiwan Patent No. M277,860 has disclosed an auxiliary lighting device for hand tools, which comprises a clip assembly to clip and position the auxiliary lighting device on a predetermined hand tool for providing auxiliary illumination.

Although these two auxiliary lighting devices described above can provide the function of illumination to facilitate the operation of the hand tool, they have respective drawbacks. First, the auxiliary lighting devices cannot be applied to hand tools of different purposes and tool handles of different sizes. Accordingly, the hand tools and the corresponding auxiliary lighting devices must be manufactured simultaneously. Second, the auxiliary lighting devices have complicated structures and complicated assembling process. In addition, the auxiliary lighting devices have many components so they have high production cost.

In view of the above-mentioned drawbacks, the present inventor makes diligent studies in providing general public with an auxiliary lighting device capable of coupling with different articles.

### SUMMARY OF THE INVENTION

It is an object of the present invention to provide an auxiliary lighting device, wherein a casing has a central through hole, and at least one light-emitting device and a battery are mounted inside the casing, wherein the light-emitting device is electrically connected with the battery so that the battery can supply electric power for the light-emitting device. In addition, the casing can be sleeved onto an article to provide auxiliary illumination, thereby increasing overall practicability and convenience.

It is another object of the present invention to provide an auxiliary lighting device, wherein a sleeve in mounted in the central through hole of the casing, and the sleeve also has a central hole of various sizes or shapes so that the casing can be sleeved onto various articles such as all kinds of hand tools or tool handles, thereby increasing overall practicability and convenience.

It is a further object of the present invention to provide an auxiliary lighting device, wherein light-emitting device comprises a light-emitting diode (LED) and a laser diode so that the auxiliary lighting device can be applied to various places and locations that require parallel and concentrated illumination, thereby increasing overall practicability and convenience.

In order to achieve the foregoing objects, an auxiliary lighting device is comprised of a casing, wherein the casing has a central through hole, and at least one light-emitting device and a battery are mounted inside the casing. The light-emitting device is electrically connected to the battery for providing auxiliary illumination.

The aforementioned and other objects and advantages of the present invention will be readily clarified in the description of the preferred embodiments and the enclosed drawings of the present invention.

### BRIEF DESCRIPTION OF THE DRAWINGS

FIG. 1 is an elevational view showing a first preferred embodiment of the present invention.

FIG. 2 is an elevational, decomposed view showing the first preferred embodiment of the present invention.

FIG. 3 is a schematic, cross-sectional view showing the assembled structure of the first preferred embodiment of the present invention.

FIG. 4 is a schematic view showing the utilization status of the first preferred embodiment of the present invention.

FIG. 5 is another schematic view showing the utilization status of the first preferred embodiment of the present invention.

FIG. 6 is an elevational, decomposed view showing a second preferred embodiment of the present invention.

FIG. 7 is a schematic, cross-sectional view showing the assembled structure of the second preferred embodiment of the present invention.

### DETAILED DESCRIPTION OF THE PREFERRED EMBODIMENT

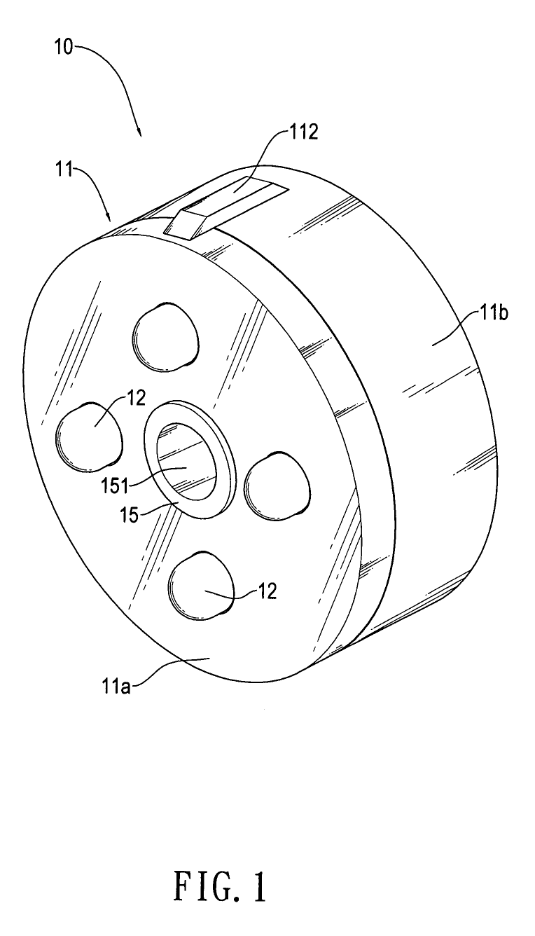

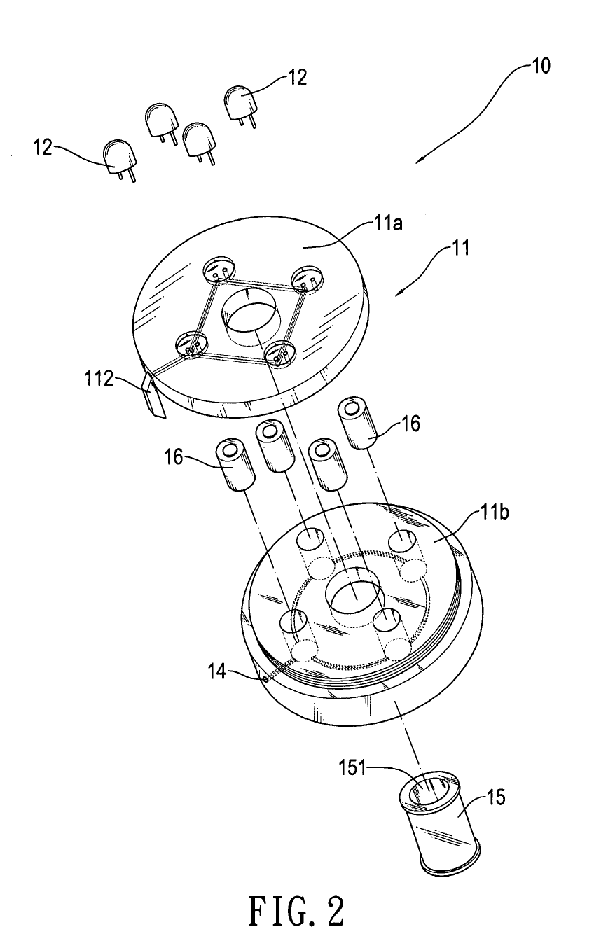

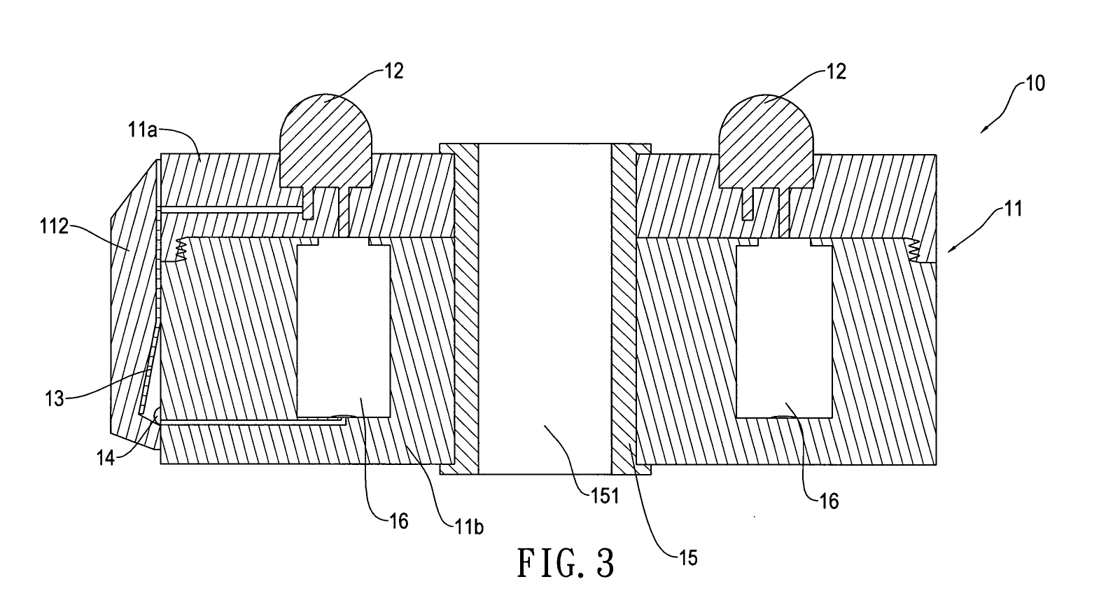

Referring to FIGS. 1 through 3, the present invention relates to an auxiliary lighting device 10, which comprises a casing 11 comprising an upper housing 11a and a lower housing 11b. The upper housing 11a has a through hole on the center. The lower housing 11b also has a through hole on the center. The upper housing 11a and the lower housing 11b are attachable to each other to form a central through hole on the casing 11. A control switch 112 is mounted on the casing 11. At least one light-emitting device 12 is mounted inside the casing 11. The at least one light-emitting device 12 comprises a light-emitting diode (LED) or comprises a light-emitting diode and a laser diode depending on the purpose of use. The at least one light-emitting device 12 is inserted into the upper housing 11a. The cathodes of these light-emitting devices 12 are electrically connected to one another. Cathodes of batteries 16 mounted inside the lower housing 11b are electrically connected to one another. A cathode-conducting plate 13 is mounted on the upper housing 11a. Anodes of these light-emitting devices 12 are electrically connected to anodes of these batteries 16, respectively. A cathode-connecting bump 14 is mounted on the lower housing 11b in such a manner that the cathode-conducting plate 13 on the upper housing 11a can be shifted to connect with the cathode-connecting bump 14 on the lower housing 11b by pushing the control switch 112 on the upper housing 11a so as to allow the batteries 16 to provide electric power for the light-emitting devices 12. In addition, a sleeve 15 is mounted in the central through hole of the casing 11. The sleeve 15 has a central hole 151 of various sizes or shapes, wherein the sleeve 15 that has the central hole 151 of various sizes or shapes may be jammed into or buckled into the central through hole of the casing 11 so that the auxiliary lighting device 10 is adaptable to various hand tools or tool handles. In this preferred embodiment, the sleeve 15 is made of rubber so that the sleeve 15 can be buckled with the central through hole of the casing 11 by means of the resilience itself.

Referring to FIGS. 1 through 3, the auxiliary lighting device 10 of the present invention is featured in that at least one light-emitting device 12 is mounted inside a casing 11 and electrically connected with a battery 16 to be supplied with electric power by the battery 16. Besides, the auxiliary lighting device 10 can be sleeved onto an article for providing auxiliary illumination. In addition, a sleeve 15 that has a central hole of various sizes or shapes is placed in the central through hole of the casing 11 to allow insertion of various articles thereinto so that the auxiliary lighting device 10 is adaptable to various hand tools or tool handles for providing auxiliary illumination.

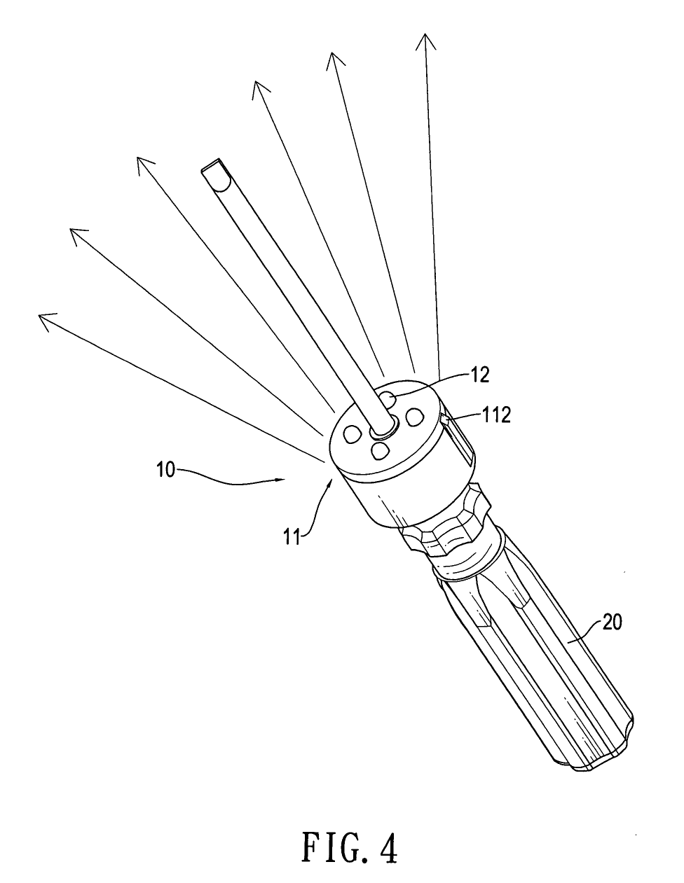

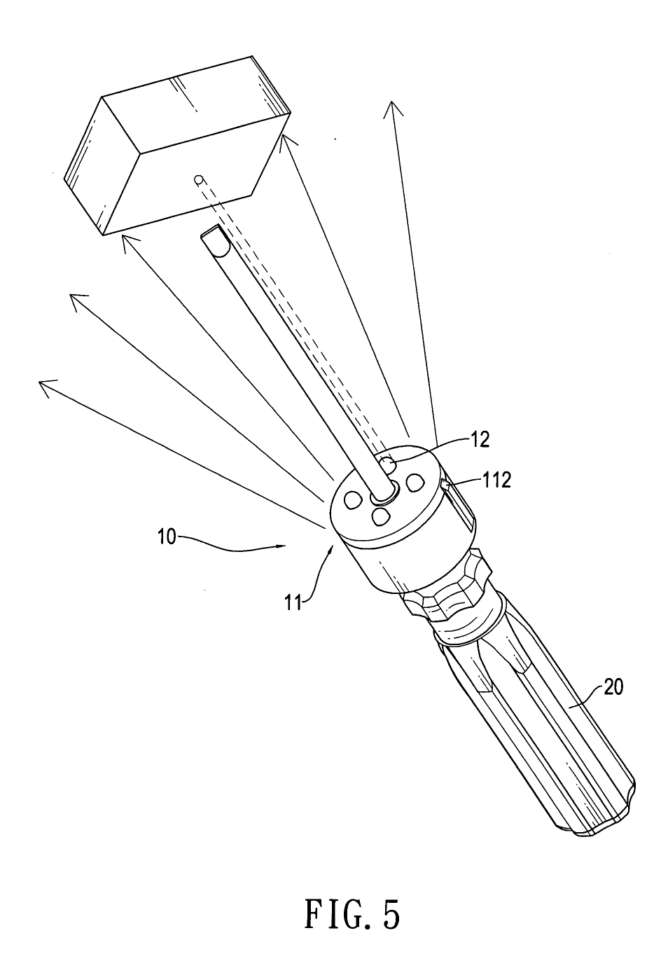

Referring to FIGS. 4 and 5, the auxiliary lighting device 10 is sleeved onto a screwdriver 20. The casing 11 is a transparent casing. Several light-emitting devices 12 are mounted inside the casing 11. In addition, a control switch 112 is mounted on the casing 11 for controlling the activation of the light-emitting devices 12. Several batteries 16 are mounted inside the casing 11 to provide the light-emitting devices 12 with the electric power. As shown in FIG. 4, the light-emitting devices 12 are light-emitting diodes (LEDs). As shown in FIG. 5, if there is a need to apply the auxiliary lighting device 10 to a location that requires parallel and concentrated illumination, a laser diode can be additionally mounted inside the casing 11. Besides, the present invention is also featured in that the auxiliary lighting device 10 is detachable from the hand tool and can be utilized alone for illumination. Accordingly, it is very convenient for the user.

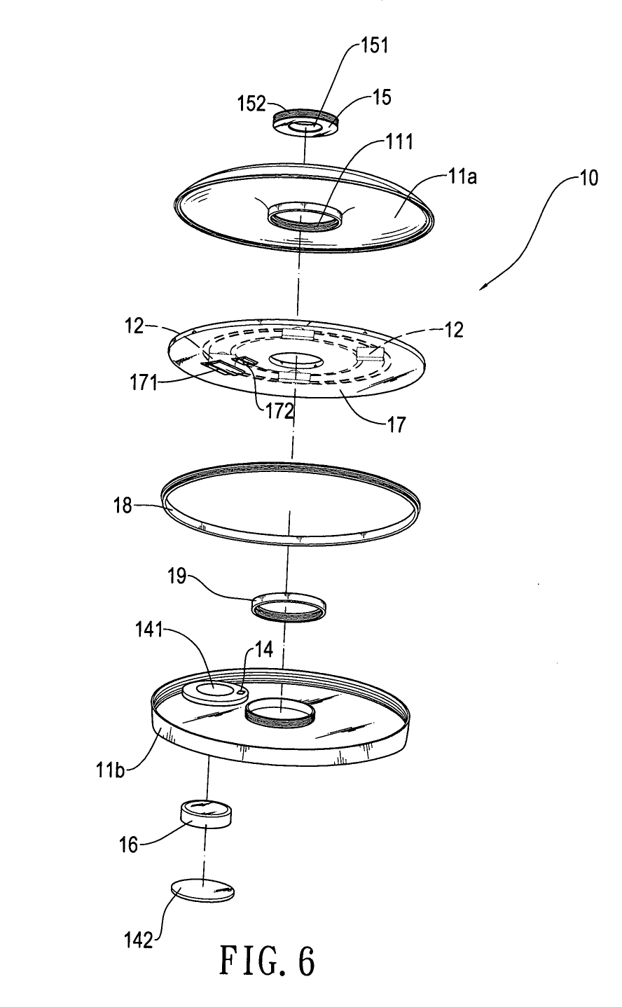

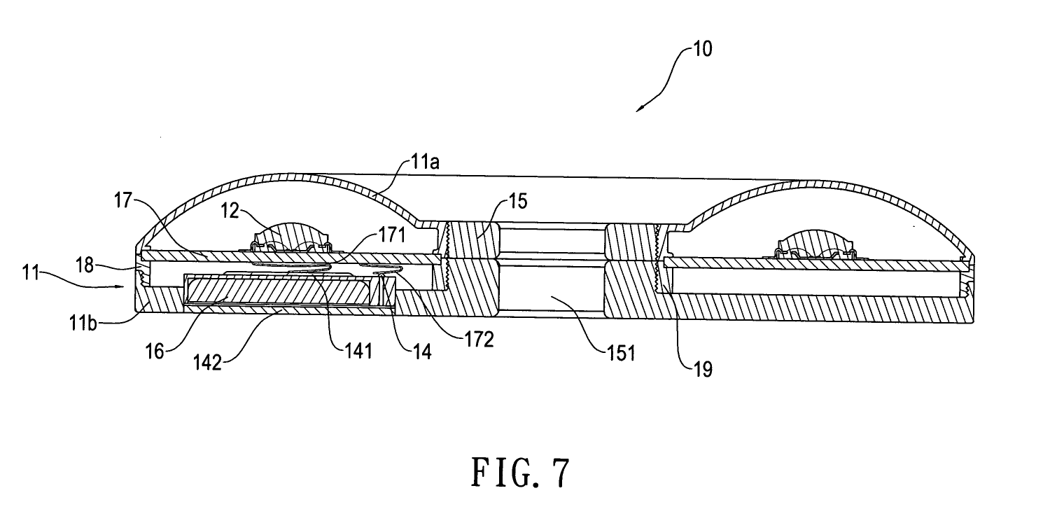

Referring to FIGS. 6 and 7, a second preferred embodiment of the present invention is shown. The auxiliary lighting device 10 comprises a casing 11 comprising an upper housing 11a and a lower housing 11b. The upper housing 11a has a through hole on the center. The lower housing 11b also has a through hole on the center. The upper housing 11a and the lower housing 11b are attachable to each other to form a central through hole on the casing 11. A sleeve 15 is mounted in the central through hole of the casing 11. The sleeve 15 has a central hole 151 of various sizes or shapes. The sleeve 15 has a sleeving part 152 on the periphery. In this preferred embodiment, the sleeving part 152 is an outer thread. The upper housing 11a has a coupling part 111 on the center corresponding to the sleeving part 152. In this preferred embodiment, the coupling part 111 is an inner thread. As a result, the sleeve 15 can be coupled with the central through hole of the casing 11 by engaging the sleeving part 152 (outer thread) of the sleeve 15 with the coupling part 111 (inner thread) on the center of the upper housing 11a. In addition, a circuit board 17 is further mounted on the inside of the casing 11. At least one light-emitting device 12 is mounted on the circuit board 17. In addition, an anode-conducting plate 171 and a cathode-conducting plate 172, which are respectively electrically connected to anode and cathode, are mounted on the circuit board 17. The circuit board 17 is located on a rotatable ring 18. The rotatable ring 18 is movably attachable to the lower housing 11b mounted under the circuit board 17. A gasket 19 is coupled to the central through hole of the lower housing 11b to balance and support the circuit board 17. A battery 16 is mounted on the inside of the lower housing 11b. An anode-connecting bump 141 and a cathode-connecting bump 14 are mounted on the top of the lower housing 11b to be respectively electrically connected with the anode-conducting plate 171 and the cathode-conducting plate 172 mounted on the circuit board 17 so that the battery 16 can supply electric power for the light-emitting device 12. In addition, the anode-connecting bump 141 and the cathode-connecting bump 14 mounted on the lower housing 11b can be connected to or disconnected from the anode-conducting plate 171 and the cathode-conducting plate 172 mounted on the circuit board 17 by rotating the lower housing 11b for controlling the activation of the light-emitting devices 12. Besides, the bottom of the battery 16 is covered with a battery cover 142. Such a structure makes it possible to replace the battery 16 by detaching the battery cover 142.

To sum up, the present invention discloses an auxiliary lighting device capable of achieving the aforementioned objects. Thus, this application is filed according to the patent law.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. An auxiliary lighting device, comprising:
a casing having a central through hole; and
at least one light-emitting device and at least one battery mounted inside said casing, wherein said at least one light-emitting device is electrically connected with said at least one battery for providing auxiliary illumination.

2. An auxiliary lighting device of claim 1, further comprising a sleeve mounted in said central through hole of said casing.

3. An auxiliary lighting device of claim 2, wherein said sleeve has a central hole for sleeving onto different articles.

4. An auxiliary lighting device of claim 1, wherein said casing comprising an upper housing and a lower housing attachable to each other, said upper housing has a through hole on the center, and said lower housing also has a through hole on the center.

5. An auxiliary lighting device of claim 1, further comprising a circuit board mounted inside said casing and a conducting plate mounted on said circuit board for electrically connecting with said at least one light-emitting device.

6. An auxiliary lighting device of claim 5, further comprising a rotatable ring mounted inside said casing, wherein said circuit board is mounted on said rotatable ring.

7. An auxiliary lighting device of claim 1, wherein said at least one light-emitting device comprises at least one light-emitting diode (LED).

8. An auxiliary lighting device of claim 1, wherein said at least one light-emitting device comprises at least one light-emitting diode and a laser diode.
